(19) United States
(12) Patent Application Publication
(10) Pub. No.: US 2011/0314387 A1
(43) Pub. Date: Dec. 22, 2011

(54) INTELLIGENT FILTERING FOR RENDER STATUS DETERMINATION IN A SCREEN SHARING SYSTEM

(75) Inventors: BENJAMIN M. GOLD, LEXINGTON, KY (US); AMY D. TRAVIS, ARLINGTON, MA (US)

(73) Assignee: INTERNATIONAL BUSINESS MACHINES CORPORATION, ARMONK, NY (US)

(21) Appl. No.: 12/818,878

(22) Filed: Jun. 18, 2010

(51) Int. Cl. G06F 3/048; G06F 15/16

(52) U.S. Cl. 715/751

(57) ABSTRACT

A shared space can be identified that represents a portion of a graphical user interface that is shared and concurrently viewable among of set of at least two different computing devices. Data can be determined for a synchronization status representing a degree to which one of the two different computing devices shows the same graphical content for the shared space as that shown by another one of the two different computing devices. The determined data can be filtered to produce filtered data that minimizes a defined subset of potential differences. The filtered data can be utilized to screen render status.

### BACKGROUND

The present invention relates to the field of data sharing and, more particularly, to intelligent filtering for render status determination in a screen sharing system.

The concept of shared viewing spaces has become a standard feature in many enterprise communication tools. Shared viewing spaces are the focal point of most online collaboration systems and Web conferencing applications. Many such software systems allow a host user to share their actual computer screen (i.e., desktop). This capability is especially valuable for tasks such as software demonstrations, training, and general data sharing using the native software application.

Generally, the host user is unaware of any delays or problems encountered by recipients receiving their shared screen. This issue is addressed by at least one patent cited in the Information Disclosure Statement. At least one of these patents teaches a screen sharing service that includes components to determine a screen render status for each recipient. Thus, screen sharing system provides the host user with feedback indicating when their screen has been completely rendered by a recipient.

However, the dynamic elements (e.g., cursor animations, Web advertisements, automatic element positioning, etc.) used in many software applications and computer systems undermine the validity of the screen render status determined by any known system or service. For example, a background application that uses an animated graphic in the toolbar on the host user's computer creates enough of a change in the display that known techniques will falsely indicate that the screen share is incomplete for the recipient.

Other systems (e.g., IBM LOTUS SAMETIME, LOTUSLIVE MEETINGS, etc.) allow the host user the option to select the software applications they wish to share, instead of a blanket desktop screen share. While this helps to limit the focus for determining the render status of a recipient, it does not account for the dynamic elements inherent in the application being shared.

Further, unintentional changes (i.e., accidentally moving the mouse pointer) made by the host user are additional impediments to accurately determining the screen render status for the recipient.

### SUMMARY

One aspect of the disclosure can include a method, computer program product, system, and/or apparatus for providing screen render status of a shared space of a graphical user interface. In the aspect, a shared space can be identified that represents a portion of a graphical user interface that is shared and that is concurrently viewable among of set of at least two different computing devices. Data can be determined for a synchronization status representing a degree to which one of the two different computing devices shows the same graphical content for the shared space as that shown by another one of the two different computing devices. The determined data can be filtered to produce filtered data that minimizes a defined subset of potential differences. For example, elements in the defined subset can be ignored when determining the screen render status. The filtered data can be utilized to screen render status.

One aspect of the disclosure can include a method, computer program product, system, and/or apparatus for providing screen render status of a shared space of a graphical user interface. In the aspect, a shared space can be identified, where the shared space is a portion or an entirety of a graphical user interface rendered upon a display of a computing device. A different display of a different computing device can present a rendered shared space of a graphical user interface that corresponds to the shared space and that is dynamically updated in real time to reflect changes to the shared space. The computing device and the different computing device can be remotely located and can be communicatively linked to each other via a network. Data for a synchronization status of the rendered shared space can be detected. The synchronization status can represent whether graphical content of rendered shared space is properly synchronized with graphical content of the shared space. At least one filter can be applied against the detected data to produce an after filtered status. The filter can minimize a significance of a defined set of differences between the rendered shared space and the shared space. In absence of the filter being applied, presence of the defined set of differences within the detected data would result in a synchronization status more adverse than an after-filtered status resulting when the at least one filter is applied. In absence of at least one of the defined set of differences being presented in the detected data, the synchronization status can be substantially the same as the after filtered status. The after filtered status can be utilized to indicate the synchronization status of the rendered shared space.

### BRIEF DESCRIPTION OF THE SEVERAL VIEWS OF THE DRAWINGS

FIG. 1 is a schematic diagram illustrating a system that automatically excludes extraneous share elements from screen render status determinations made by a screen sharing system in accordance with embodiments of the inventive arrangements disclosed herein.

FIG. 2 is an illustrated process flow describing the operation of the render status filtering component within a screen sharing system in accordance with an embodiment of the inventive arrangements disclosed herein.

FIG. 3 is a flow chart of a method detailing the operation of the render status filtering component in accordance with an embodiment of the inventive arrangements disclosed herein.

### DETAILED DESCRIPTION

The disclosure provides a solution for excluding changes in elements of a shared space deemed extraneous when determining the screen render status (also referred to as a synchronization status) during a screen sharing session. A screen sharing system utilizing a screen render status component can be configured to include a render status filtering component. The render status filtering component can be configured to apply filtering intelligence and user filtering preferences to screen render data received from a recipient of the screen sharing session. The filtered screen render data can then be processed by the screen render status component to generate a screen render status for the recipient that is reflective of key elements of the shared space.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

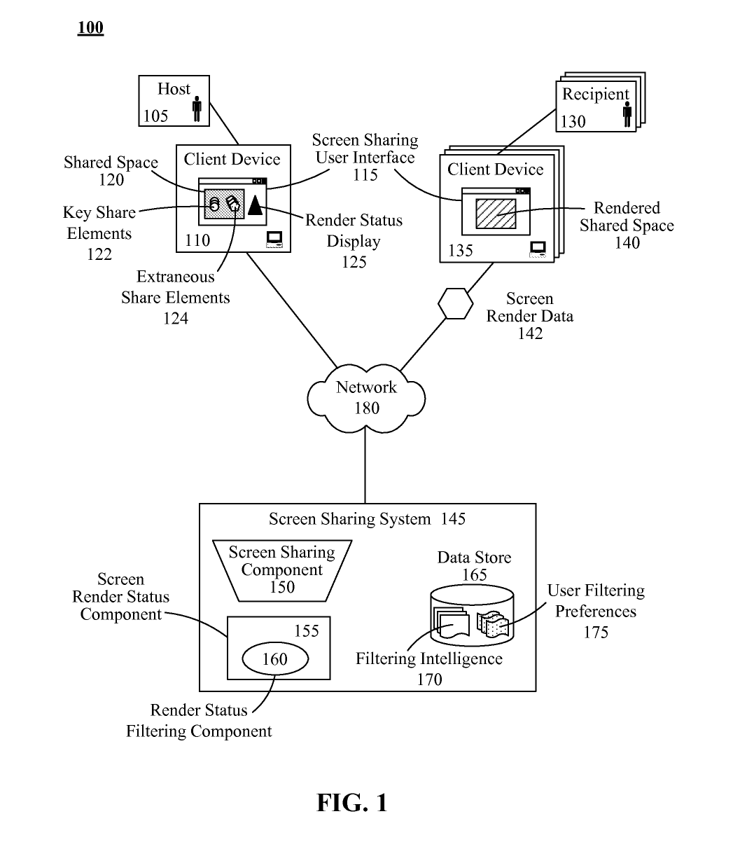

FIG. 1 is a schematic diagram illustrating a system 100 that automatically excludes extraneous share elements 124 from screen render status determinations made by a screen sharing system 145 in accordance with embodiments of the inventive arrangements disclosed herein. In system 100, a host 105 can use a screen sharing user interface 115 of a screen sharing system 145 to share a shared space 120 over a network 180 with one or more recipients 130.

The screen sharing system 145 can represent the hardware and/or software components required to support screen sharing operations between the screen sharing user interfaces 115 of the host 105 and recipients 130. While a screen sharing system 145 can be comprised of a variety of components, the components of particular import to this embodiment of the disclosure can include the screen sharing component 150 and the screen render status component 155. In one non-limiting embodiment, the screen sharing component and screen render status component can be implemented in accordance with details described in U.S. Patent Publication 2006/0271624. The screen sharing system 145 can also include a screen sharing user interface 115 and a data store 165 containing filtering intelligence 170 and user filtering preferences 175.

The screen sharing user interface 115 can represent a software application capable of running on the client device 110 and 135 of the host 105 and recipients 130. Client device 110 and 135 can represent a variety of computing devices capable of interacting with the screen sharing system 145, including, but not limited to a desktop computer, a laptop computer, a workstation, a network server, and the like.

Using the screen sharing user interface 115, the host 105 can define a shared space 120 to be sent to the designated recipients 130 of the screen sharing session. The shared space 120 can represent one or more bounded areas recognized by the screen sharing system 145 such as the window of a specific software application running on the client device 110 or the desktop display. In one embodiment, the shared space 120 can be view only, where a recipient 130 is unable to affect behavior of the space 120. In one embodiment, the shared space 120 can be interactive, where a recipient 130 can affect behavior of the space 120 by interacting with the corresponding rendered shared space 140. The shared space 120 can be presented (as rendered space 140) on one or more different client devices 135 in real-time or near real time.

In general, the visual information contained in the shared space 120 on the host's 105 client device 110 can be conveyed via the screen sharing component 150 of the screen sharing system 145 and network 180 to the screen sharing user interface 115 running on the client device 135 of the recipient 130, resulting in the rendered shared space 140.

It should be noted that this basic function of the screen sharing system 145 is performed on the entirety of the shared space 120, regardless of the definition of the shared space 120. That is, a shared space 120 defined as the host's 105 desktop shares all the information displayed in the host's 105 desktop to the recipient 130; an application window shared space 120 conveys all the contents of only the application window. As such, a host 105 can be required to take extra care when defining or selecting the shared space 120 to be used; sharing too much or too little can cause additional problems.

For example, when sharing one's desktop 120, the host 105 may need to take extra measures to ensure that only the software applications that they want to share are running to limit unwanted interruptions (i.e., email and chat pop-up windows). Performance of these extra measures can be required every time the host 105 initiates a screen sharing session.

Depending on the screen sharing system 145, the host 105 may be able to restrict the shared space 120 to a few designated application windows. While this can eliminate the need for extra measures, the host 105 may not be able to add new application windows to the screen sharing session.

For example, the host 105 can designate the windows of App X and App Y as the shared space 120 for a product demonstration. Should the customer 130 request to see App Z during the demonstration, the host 105 may be required to terminate the current screen sharing session in order to start a new screen sharing session that includes App Z in the shared space 120.

When the recipient's 130 screen sharing user interface 115 receives data for the shared space 120, screen render data 142 can be generated and conveyed to the screen render status component 155. The screen render status component 155 can utilize the screen render data 142 to provide the host 105 with feedback as to the completeness of the rendered shared space 140 (i.e., as taught in U.S. Patent Publication 2006/0271624, for example—other examples are possible and the disclosure is not to be construed as limited to use of techniques detailed in U.S. Patent Publication 2006/0271624).

For example, due to data loss/latency experienced by the network 180 during the transmission of the shared space 120, the screen render status generated by the screen render status component 155 and presented in the render status display 125 can indicate that the rendered shared space 140 is lacking ten percent of the original shared space 120. Depending on which ten percent is missing, it is possible that the host 105 can proceed with the screen sharing session (i.e., when sharing a desktop 120, missing the rendering of desktop icons is not critical if focused on an application window). It should be noted that, screen render status generated by conventional screen sharing systems (with render status abilities) cannot help the host 105 to identify if any data loss of the rendered shared space 140 is acceptable.

Thus, this embodiment of the disclosure improves upon known systems by enhancing the functionality of the screen render status component 155 with a render status filtering component 160. The render status filtering component 160 can be configured to apply filtering intelligence 170 and/or user filtering preferences 175 to the screen render data 142 prior to the determination of the screen render status by the screen render status component 155.

To illustrate the functionality of the render status filtering component 160, it can be helpful to think of the shared space 120 as an abstract collection of key share elements 122 and extraneous share elements 124. A key share element 122 can represent an area or container of the shared space 120 whose changes are a focus of the screen sharing session. Conversely, an extraneous share element 124 can represent an area or container of the shared space 120 whose changes are not a focus of the screen sharing session. Key share elements 122 and extraneous share elements 124 can vary based on application and/or client device 110 and 135 configurations. Different types of filters can be defined for the filtering component 160, which include system level filters, application level filters and user defined filters, each of which can be specified within customizable settings, such as those of the filtering intelligence 170 and/or user filtering preferences 175.

To show a filtering example, a Web page presenting text in a main frame and advertisements in a secondary frame can be presented within the shared space 120. Assuming that the Web page is being viewed for the text and not the advertisements, the main frame can be determined as a key share element 122 and the secondary frame as an extraneous share element 124. A system or application level filter can detect a presence of an advertisement and block it. Additionally, a user can draw/define a region (via a mouse, for example) in which the advertising is presented and create a filter to exclude this region (e.g., the advertisement) when determining the render status of a shared space.

Thus, it can be the goal of the render status filtering component 160 to exclude extraneous share elements 124 (defined at a system level, application level, and/or user level) from the screen render data 142 before the screen render status component 155 determines the screen render status of the recipient 130. To reach this goal the render status filtering component 160 can utilize filtering intelligence 170 and/or user filtering preferences 175.

The filtering intelligence 170 can express rules that define key share elements 122, extraneous share elements 124, and/or behaviors within these elements 122 and 124. Filtering intelligence 170 can be defined at the system level, application level, and/or user level (as can user filtering preferences 175). The render status filtering component 160 can include algorithms to reconcile precedence between the different levels.

System level examples of filtering intelligence 170 can include rules that ignore changes to the task bar, task manager indicator, clock applications, cursor movement within a predefined distance tolerance, and the like. System level examples of filtering intelligence 170 can also ignore client device 135 “pop-up” windows that obscure a small portion of the rendered shared space 140. Constraints or limitations can be established (in parameters of filtering intelligence 170) for how much a rendered screen space 140 is able to be ignored without triggering an adverse rendering status. For example, a temporal constraint can permit a pop-up to be presented on device 135 for three seconds or less, without triggering an adverse render status. Here, an adverse render status can be one displayable to host 105. In another example, spatial constraints can be established at the system level, such as permitting pop-ups to obscure screen borders lacking semantic content but trigging adverse status messages when pop-ups obscure semantic content that would otherwise be displayed in the rendered shared space 140. These are just a few system-level examples and others are contemplated.

Application level examples of filtering intelligence 170 can include rules that ignore changes to animated objects (except in an animation application), application panes not in focus, cursor blinking, status bars, and the like. Application-level content filters can be used to determine whether specific content items are “significant” or not (e.g., are key share elements 122 or extraneous share elements 124). For example, if the shared space 120 includes a user interface of an Instant Messaging (IM) communication application, text exchanges presented in a window can be defined (using application-level settings of filtering intelligence 170) as being key elements, while friend status indicators (e.g., a buddy list) can be defined as being extraneous share elements 124. Application-level filter rules, constraints, and settings can be applied to layout and interactive features of an application interface (shown in shared space 120) as well as to application level semantic events.

User defined filters can be filters explicitly defined for a presented region of the shared space 120. In other words, user defined filters can be interface level filters that apply to a specific shared space 120. In a Web page presenting example, a main frame and a set of advertisements in a secondary frame can be presented in shared space 120. A user (e.g., host 105) can utilize a mouse pointer to define an area of the screen that is to be excluded, where the mouse defined area is considered a user defined (interface level) filter. In one embodiment, only the host 105 may be permitted to specify user defined filters. In one embodiment, a recipient 130 can specify user defined filters for the rendered shared space 140. In one embodiment, both the host 105 and recipient 130 can specify user defined filters. In one implementation permitting both host 105 and recipient 130 defined user-level filters, the host 105 may have higher (administrator-level) privileges so that he/she is able to override (or at least view) recipient 130 established, user-level filters that affect the render status of space 140 (shown in render status display 125).

Filtering intelligence 170 can be managed in a variety of ways, depending upon the implementation of the render status filtering component 160 and screen sharing system 145. Examples can include, but are not limited to, a generic complement of filtering intelligence 170 deployed with the screen sharing system 145, manual entry via an administrative interface (not shown) of the screen sharing system 145, importing from a third party, and the like.

The user filtering preferences 175 can represent user-configurable parameters for adjusting the behavior of the render status filtering component 160. Using the user filtering preferences 175, the host 105 can customize the handling of screen render data 142 for their screen sharing sessions. Configuration of the user filtering preferences 175 can be made using the screen sharing user interface 115.

The filtering component 160 can be cooperatively utilized with other screen sharing system 145 options (not shown). For example, in one contemplated embodiment, an intentionally filtering element can be utilized to intentionally block or filter elements of the shared space 120 from being rendered in corresponding space(s) 140. The filtering intelligence 170 can be used to enable this type of intentional filtering. Filtering can be imposed to conserve bandwidth, to protect confidentiality of elements of shared space 120 and the like. Thus, although the status component 160 can be used independent of an active filter (in one contemplated embodiment), it can similarly be used cooperatively with an active filter (in another contemplated embodiment).

In one embodiment, filtering intelligence 170 can be used to vary a refresh rate of different portions of the shared space 120. For instance, a portion of the space 120 (an active one, receiving focus) can be refreshed with a greater rate than a different portion of space 120. The differences in refresh rates can ensure real time updates when bandwidth is limited. Regardless, the render status filtering component 160 and screen render status component 155 can optionally consider any intentional differences in refresh rates defined for sub-portions of shared space 120 when determining whether there is an issue with a render status.

Network 180 can include any hardware/software/and firmware necessary to convey data encoded within carrier waves. Data can be contained within analog or digital signals and conveyed though data or voice channels. Network 180 can include local components and data pathways necessary for communications to be exchanged among computing device components and between integrated device components and peripheral devices. Network 180 can also include network equipment, such as routers, data lines, hubs, and intermediary servers which together form a data network, such as the Internet. Network 180 can also include circuit-based communication components and mobile communication components, such as telephony switches, modems, cellular communication towers, and the like. Network 180 can include line based and/or wireless communication pathways.

As used herein, presented data store 165 can be a physical or virtual storage space configured to store digital information. Data store 165 can be physically implemented within any type of hardware including, but not limited to, a magnetic disk, an optical disk, a semiconductor memory, a digitally encoded plastic memory, a holographic memory, or any other recording medium. Data store 165 can be a stand-alone storage unit as well as a storage unit formed from a plurality of physical devices. Additionally, information can be stored within data store 165 in a variety of manners. For example, information can be stored within a database structure or can be stored within one or more files of a file storage system, where each file may or may not be indexed for information searching purposes. Further, data store 165 can utilize one or more encryption mechanisms to protect stored information from unauthorized access.

Although components of system 100 show a centralized system 145 is utilized to facilitate the sharing of shared space 120 other implementation choices are contemplated and are to be considered within scope of the disclosure. For example, a peer-to-peer (without a central server) embodiment can be used. In another embodiment, device 110 can function as a server for screen sharing purposes—where one or more screen sharing components 150, 155, 165 execute on the client device 110. In one embodiment, screen status rendering components and/or status filtering components 160 can execute of a client device 135 providing a rendered shared space 140, so that the status of device 135 is filtered (filtering component 160) before status messages are sent back to device 110 (or system 145).

In another embodiment, the render status functionality can be an externally implemented functionality added to an existing screen sharing system 145. For example, the render status functionality can be provided as an optional Web service. This Web service can optionally be provided by middleware. Further, a software service providing the filtered status functionality can be a software service of a Service Oriented Architecture (SOA).

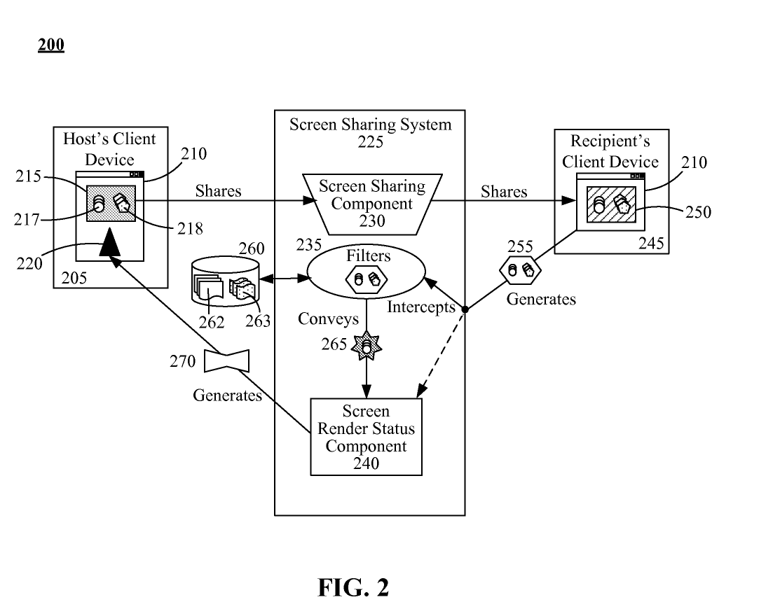

FIG. 2 is an illustrated process flow 200 describing the operation of the render status filtering component 235 within a screen sharing system 225 in accordance with embodiments of the inventive arrangements disclosed herein. Process flow 200 can be performed within the context of system 100 or any other screen sharing system configured to intelligently filter screen render data before generating a screen render status.

Process flow 200 can illustrate the affect of the render status filtering component 235 during generation of the screen render status 270 for the rendered shared space 240 presented on a recipient's client device 245. The actions of process flow 200 can initiate from the host's client device 205.

The screen sharing user interface 210 can be running upon the host's client device 205. A shared space 215 comprising key share elements 217 and extraneous share elements 218 can be shared from the host's client device 205 via the screen sharing component 230 of the screen sharing system 225 to the recipient's client device 245.

A rendered shared space 240 can be presented within the screen sharing user interface 210 running on the recipient's client device 245. It should be noted that the rendered shared space 240 contains the same key share elements 217 and extraneous share elements 218 as the original shared space 215.

The screen sharing user interface 210 on the recipient's client device 245 can generate screen render data 255 and send the screen render data 255 to the screen sharing system 225. In a conventional screen sharing system 225 utilizing a screen render status component 240, the screen render data 255 would likely be conveyed directly to the screen render status component 240, shown by the dashed arrow.

However, in one embodiment of the disclosure, the render status filtering component 235 can intercept the screen render data 255 before it is sent to the screen render status component 240. The render status filtering component 235 can then use the filtering intelligence 262 and user filtering preferences 263 obtained from data store 260 to filter the screen render data 255.

The filtered screen render data 265 can then be conveyed to the screen render status component 240. The screen render status component 240 can generate the screen render status 270 of the rendered shared space 240 using the filtered screen render data 265. The screen render status 270 can then be conveyed to the screen sharing user interface 210 of the host's client device 205 for presentation within the render status display 220.

As used herein, presented data store 260 can be a physical or virtual storage space configured to store digital information. Data store 260 can be physically implemented within any type of hardware including, but not limited to, a magnetic disk, an optical disk, a semiconductor memory, a digitally encoded plastic memory, a holographic memory, or any other recording medium. Data store 260 can be a stand-alone storage unit as well as a storage unit formed from a plurality of physical devices. Additionally, information can be stored within data store 260 in a variety of manners. For example, information can be stored within a database structure or can be stored within one or more files of a file storage system, where each file may or may not be indexed for information searching purposes. Further, data store 260 can utilize one or more encryption mechanisms to protect stored information from unauthorized access.

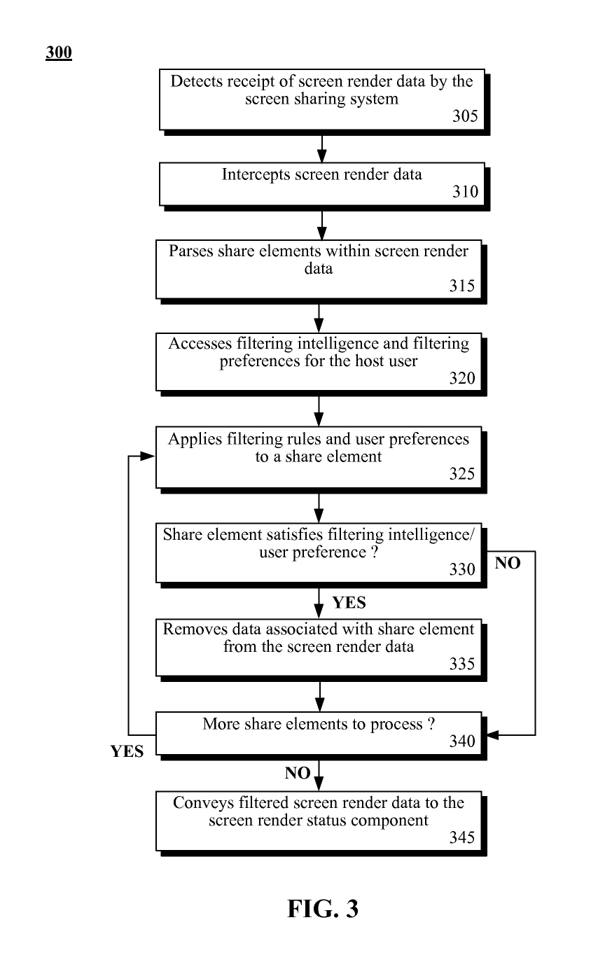

FIG. 3 is a flow chart of a method 300 detailing the operation of the render status filtering component in accordance with embodiments of the inventive arrangements disclosed herein. Method 300 can be performed within the context of system 100 and/or process flow 200.

Method 300 can begin in step 305 where the render status filtering component can detect the receipt of screen render data by the screen sharing system. In step 310, the screen render data can be intercepted before it can be conveyed to the screen render status component.

The share elements contained within the screen render data can be parsed in step 315. In step 320, the filtering intelligence and filtering preferences of the host user can be accessed. The filtering intelligence and user filtering preferences can then be applied to a share element in step 325.

In step 330, it can be determined if the share element satisfies the filtering intelligence and/or filtering preferences. When the share element satisfies the filtering intelligence/user filtering preferences (i.e., the share element is determined to be extraneous), step 335 can be performed where the data associated with the share element can be removed from the screen render data.

When the share element does not satisfy the filtering intelligence/user filtering preferences (i.e., the share element is determined to be key) or upon completion of step 335, it can be determined if there are more share elements to process in step 340. When there are more share elements to process, flow can return to step 325 to repeat the application of filtering intelligence/user filtering preferences to the next share element.

When there are no more share elements to process, the filtered screen render data can be conveyed to the screen render status component in step 345.

It should be appreciated that in one embodiment, both key and non-key elements and their rendering status can be conveyed to a screen render status component 345. That is, instead of removing the data in step 335, the data can be retained, but labeled as being non-key. The render status component 345 can then utilize this data to perform any desired set of actions. For example, a sharing client (e.g., 110) can be provided with a continuous status indicator of key and non-key elements of each remote device (e.g., 140) that is rendering the shared space. This way, a user (e.g., host 105) of the sharing client can be continuously apprised of all available information in an easy to digest form, as opposed to having a set of the available information intentionally obscured. For example, a status bar showing different colors to indicate different rendering status of recipient viewed shared spaces can be graphically shown to the host 105 (where options exist to show/hide non-key element status indicators).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for providing screen render status of a shared space of a graphical user interface comprising:
identifying a shared space that represents at least a portion of a graphical user interface that is shared and concurrently viewable among of set of at least two different computing devices;
determining data for a synchronization status representing a degree to which one of the two different computing devices shows the same graphical content for the shared space as that shown by another one of the two different computing devices;
filtering the determined data to produce filtered data that minimizes a defined subset of potential differences; and
utilizing the filtered data to produce a screen render status.

2. The method of claim 1, said filtering comprising:
eliminating content matching the defined subset from the determined data during the filtering so that the content matching the defined subset is ignored when producing the screen render status.

3. The method of claim 1, further comprising:
parsing the determined data into a set of key share elements and a set of extraneous share elements, wherein the defined subset of potential differences are used to determine whether elements of the determined data are to be parsed into the set of key share elements or the set of extraneous share elements; and
when producing the screen render status, giving more weight to the key share elements than to the extraneous share elements.

4. The method of claim 3, further comprising:
producing the screen render status using only the set of key share elements and ignoring the set of extraneous share elements.

5. The method of claim 1, wherein the defined subset of potential differences are values configurable by a user receiving the screen render status.

6. The method of claim 1, wherein the defined subset of potential differences are values configurable by a user of a device from which the screen render status was generated.

7. The method of claim 1, further comprising:
defining one of the at least two different computing devices as a host computing device, which is linked to a display showing a graphical user interface, at least a portion of which is used to defined the shared space; and
presenting the screen render status on the graphical user interface of the host computing device to indicate whether other ones of the at least two devices are synchronized properly with the shared space.

8. The method of claim 3, further comprising:
defining one of the at least two different computing devices as a host computing device, which is linked to a display showing a graphical user interface, at least a portion of which is used to defined the shared space; and
presenting at least two separate indicators on the graphical user interface of the host computing device, one of the two separate indicators being for the key share elements and another of the two separate indicators being for the extraneous share elements, wherein the at least two separate indicators are for the same computing device, which is one of the at least two different computing devices.

9. The method of claim 1, wherein the filtering of the determined data is performed using system level filters, application level filters, and user defined interface level filters.

10. A computer program product comprising a computer readable storage medium having computer usable program code embodied therewith, the computer usable program code comprising:
computer usable program code stored in a tangible storage medium, when said computer usable program code is executed by a processor it is operable to identify a shared space represents a portion of a graphical user interface that is shared and concurrently viewable among of set of at least two different computing devices;
computer usable program code stored in a tangible storage medium, when said computer usable program code is executed by a processor it is operable to determine data for a synchronization status representing a degree to which one of the two different computing devices shows the same graphical content for the shared space as that shown by another one of the two different computing devices;
computer usable program code stored in a tangible storage medium, when said computer usable program code is executed by a processor it is operable to filter the determined data to produce filtered data that minimizes a defined subset of potential differences; and
computer usable program code stored in a tangible storage medium, when said computer usable program code is executed by a processor it is operable to utilize the filtered data to produce a screen render status.

11. The computer program product of claim 10, further comprising:
computer usable program code stored in a tangible storage medium, when said computer usable program code is executed by a processor it is operable to parse the determined data into a set of key share elements and a set of extraneous share elements, wherein the defined subset of potential differences are used to determine whether elements of the determined data are to be parsed into the set of key share elements or the set of extraneous share elements; and
when producing the screen render status, give more weight to the key share elements than to the extraneous share elements.

12. A method for providing screen render status of a shared space of a graphical user interface comprising:
identifying a shared space of at least a portion of a graphical user interface rendered upon a display of a computing device, wherein a different display of a different computing device presents a rendered shared space of a graphical user interface that corresponds to the shared space and that is dynamically updated in real time to reflect changes to the shared space, wherein the computing device and the different computing device are remotely located and communicatively linked to each other via a network;
detecting data for a synchronization status of the rendered shared space, wherein the synchronization status represents whether graphical content of rendered shared space is properly synchronized with graphical content of the shared space;
applying at least one filter against the detected data to produce an after filtered status, wherein said at least one filter minimizes a significance of a defined set of differences between the rendered shared space and the shared space, wherein in absence of the filter being applied presence of the defined set of differences within the detected data would result in a synchronization status more adverse than an after-filtered status resulting when the at least one filter is applied, and wherein in absence of at least one of the defined set of differences being presented in the detected data, the synchronization status is substantially the same as the after filtered status; and
utilizing the after filtered status to indicate the synchronization status of the rendered shared space.

13. The method of claim 12, wherein the applying of the filter ignores the defined set of differences so that those differences are ignored when producing the synchronization status.

14. The method of claim 12, further comprising:
parsing the detected data into a set of key share elements and a set of extraneous share elements, wherein the defined subset of potential differences are used to determine whether elements of the detected data are to be parsed into the set of key share elements or the set of extraneous share elements; and
when producing the synchronization status, giving more weight to the key share elements than to the extraneous share elements.

15. The method of claim 14, further comprising
producing the synchronization status using only the set of key share elements and ignoring the set of extraneous share elements.

16. The method of claim 12, wherein the defined subset of potential differences are values configurable by a user receiving the synchronization status.

17. The method of claim 12, wherein the defined subset of potential differences are values configurable by a user of a device from which the synchronization status was generated.

18. The method of claim 12, further comprising:
defining the computing devices as a host computing device, which comprises a display comprising a graphical user interface, at least a portion of which is used to defined the shared space; and
presenting the synchronization status on the graphical user interface of the host computing device to indicate whether the different computing device is synchronized properly with the shared space.

19. The method of claim 13, further comprising:
defining the computing devices as a host computing device, which comprises a display comprising a graphical user interface, at least a portion of which is used to defined the shared space; and
presenting at least two separate indicators on the graphical user interface of the host computing device, one of the two separate indicators being for the key share elements and another of the two separate indicators being for the extraneous share elements, wherein the at least two separate indicators are for the different computing device.

20. The method of claim 12, wherein the applying of the at least one filter applies system level filters, application level filters, and user defined interface level filters.

21. A computer program product comprising a computer readable storage medium having computer usable program code embodied therewith, the computer usable program code comprising:
computer usable program code stored in a tangible storage medium, when said computer usable program code is executed by a processor it is operable to identify a shared space of at least a portion of a graphical user interface rendered upon a display of a computing device, wherein a different display of a different computing device presents a rendered shared space of a graphical user interface that corresponds to the shared space and that is dynamically updated in real time to reflect changes to the shared space, wherein the computing device and the different computing device are remotely located and communicatively linked to each other via a network;
computer usable program code stored in a tangible storage medium, when said computer usable program code is executed by a processor it is operable to detect data for a synchronization status of the rendered shared space, wherein the synchronization status represents whether graphical content of rendered shared space is properly synchronized with graphical content of the shared space;
computer usable program code stored in a tangible storage medium, when said computer usable program code is executed by a processor it is operable to apply at least one filter against the detected data to produce an after filtered status, wherein said at least one filter minimizes a significance of a defined set of differences between the rendered shared space and the shared space, wherein in absence of the filter being applied presence of the defined set of differences within the detected data would result in a synchronization status more adverse than an after-filtered status resulting when the at least one filter is applied, and wherein in absence of at least one of the defined set of differences being presented in the detected data, the synchronization status is substantially the same as the after filtered status; and
computer usable program code stored in a tangible storage medium, when said computer usable program code is executed by a processor it is operable to utilize the after filtered status to indicate the synchronization status of the rendered shared space.

22. The computer program product of claim 21, further comprising:
computer usable program code stored in a tangible storage medium, when said computer usable program code is executed by a processor it is operable to parse the determined data into a set of key share elements and a set of extraneous share elements, wherein the defined subset of potential differences are used to determine whether elements of the determined data are to be parsed into the set of key share elements or the set of extraneous share elements; and
when producing the synchronization status, give more weight to the key share elements than to the extraneous share elements.
